(19) United States
(12) Patent Application Publication
(10) Pub. No.: US 2025/0141151 A1
(43) Pub. Date: May 1, 2025

(54) Connector and Connector Assembly

(71) Applicant: Tyco Electronics (Shanghai) Co., Ltd., Shanghai (CN)

(72) Inventors: Wei Zhang, Shanghai (CN); Ming Shi, Shanghai (CN); Xiaozhi (George) Fu, Shanghai (CN); Zhao Cheng, Shanghai (CN); Dingbing (Frank) Fan, Shanghai (CN)

(73) Assignee: Tyco Electronics (Shanghai) Co., Ltd., Shanghai (CN)

(21) Appl. No.: 18/926,437

(22) Filed: Oct. 25, 2024

(30) Foreign Application Priority Data
Oct. 25, 2023 (CN) 202322877072.1

(51) Int. Cl. H01R 13/52; H01R 12/59; H01R 13/516; H01R 13/639

(52) U.S. Cl. CPC H01R 13/5202; H01R 12/59; H01R 13/516; H01R 13/639

(57) ABSTRACT

A connector includes a housing having a slot and a first glue filling cavity communicated with the slot, a flexible circuit board inserted into the housing through the slot, and a first sealant formed by a glue filled into the first glue filling cavity and the slot. The first sealant is bonded with the flexible circuit board and the housing to seal between the flexible circuit board and the housing.

### CROSS-REFERENCE TO RELATED APPLICATION

This application claims the benefit of the filing date under 35 U.S.C. § 119 (a)-(d) of Chinese Patent Application No. 202322877072.1, filed on Oct. 25, 2023.

### FIELD OF THE INVENTION

The present invention relates to a connector and a connector assembly comprising the connector.

### BACKGROUND OF THE INVENTION

A flexible circuit board connector typically includes a housing and a Flexible Printed Circuit (FPC). The flexible circuit board is inserted into the housing for electrical contact with terminals of a mating connector inserted into the housing. Due to the sheet-like and flexible nature of the flexible circuit board, it is difficult to achieve sealing between the flexible circuit board and the housing using a sealing ring. Therefore, there is often no sealing between the flexible circuit board and the housing, and water vapor can easily enter the housing through the gap between the flexible circuit board and the housing. Existing flexible circuit board connectors are not waterproof.

### SUMMARY OF THE INVENTION

A connector includes a housing having a slot and a first glue filling cavity communicated with the slot, a flexible circuit board inserted into the housing through the slot, and a first sealant formed by a glue filled into the first glue filling cavity and the slot. The first sealant is bonded with the flexible circuit board and the housing to seal between the flexible circuit board and the housing.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector assembly according to an exemplary embodiment;

FIG. 2 shows an illustrative exploded view of a connector assembly according to an exemplary embodiment;

FIG. 3 shows a longitudinal sectional view of a connector assembly according to an exemplary embodiment;

FIG. 4 shows a longitudinal exploded sectional view of a connector assembly according to an exemplary embodiment;

FIG. 5 shows an illustrative exploded sectional view of a connector according to an exemplary embodiment; and

FIG. 6 shows an illustrative exploded sectional view of a mating connector according to an exemplary embodiment.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

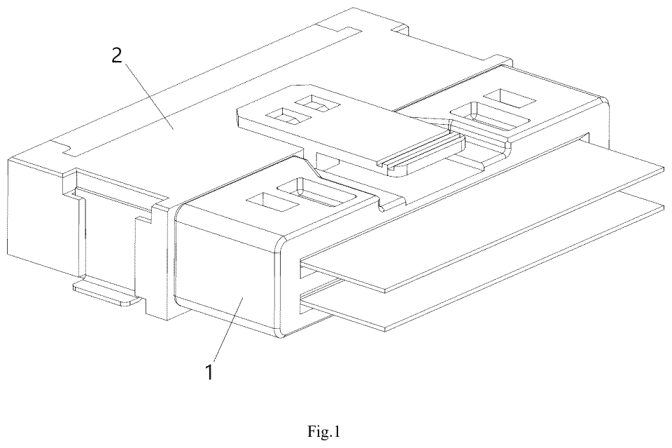

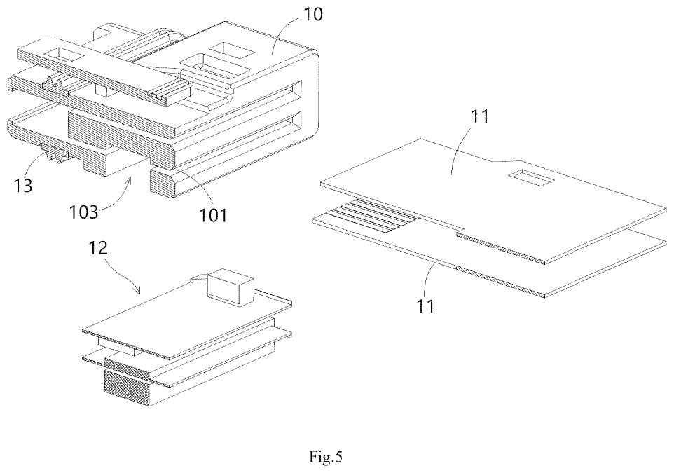

As shown in FIGS. 1 to 6, in an exemplary embodiment of the present invention, a connector 1 is disclosed. The connector 1 includes a housing 10, a flexible circuit board 11, and a first sealant 12. The housing 10 is formed with a slot 101 and a first glue filling cavity 103 communicated with the slot 101. The flexible circuit board 11 is inserted into the housing 10 through the slot 101. The first sealant 12 is formed by glue filled into the first glue filling cavity 103 and the slot 101. The glue is filled into the first glue filling cavity 103 and flows into the slot 101. The first sealant 12 is bonded with the flexible circuit board 11 and the housing 10 to achieve sealing between the flexible circuit board 11 and the housing 10. In this way, it is possible to prevent water vapor from entering the housing 10 through the gap between the flexible circuit board 11 and the housing 10.

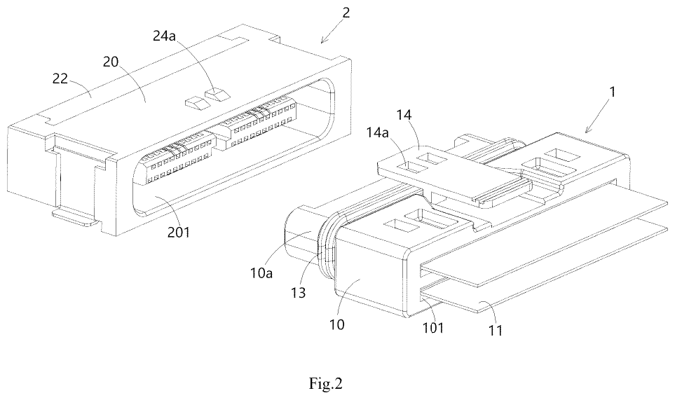

As shown in FIGS. 2 to 4, in the illustrated embodiments, the connector 1 further comprises a sealing ring 13, which is mounted on the housing 10 and is suitable for being compressed between the outer peripheral surface of the housing 10 and the inner peripheral surface of the mating housing 20 of the mating connector 2, for achieving sealing between the housing 10 and the mating housing 20. In this way, it is possible to prevent water vapor from entering the housing 10 and the mating housing 20 through the gap between the housing 10 and the mating housing 20.

As shown in FIGS. 1 to 5, in the illustrated embodiments, the connector 1 comprises two flexible circuit boards 11, which are spaced apart in the height direction of the housing 10 and overlap with each other. There are two slots 101 formed in the housing 10, and two flexible circuit boards 11 are respectively inserted into the housing 10 through two slots 101.

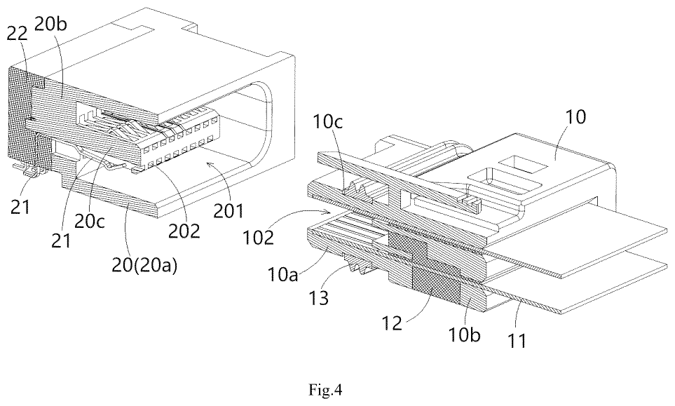

As shown in FIG. 4, in the illustrated embodiments, the housing 10 has a front housing portion 10a and a rear housing portion 10b opposite to each other in its axial direction, and a receiving chamber 102 is formed in the front housing portion 10a that allows for the insertion of a tongue portion 20c of the mating housing 20. The slot 101 is formed in the rear housing portion 10b and communicated with the receiving chamber 102 to allow the flexible circuit board 11 to be inserted into the receiving chamber 102 through the slot 101.

As shown in FIG. 4, in the illustrated embodiments, a sealing ring installation groove 10c is formed on the outer surface of the front housing portion 10a, and the sealing ring 13 is installed in the sealing ring installation groove 10c.

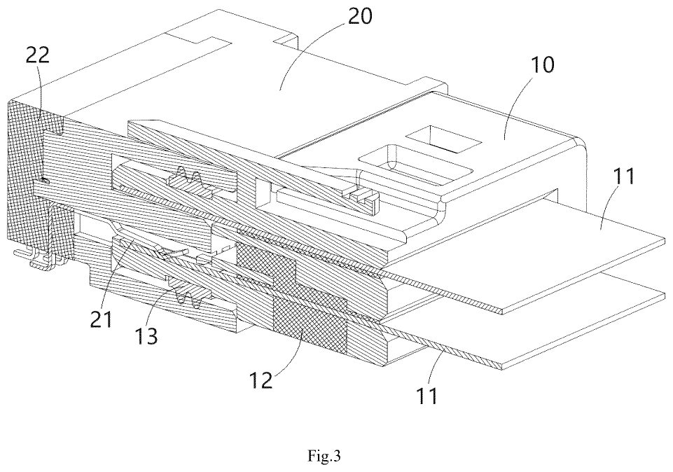

As shown in FIGS. 3 and 4, in the illustrated embodiments, the receiving chamber 102 of the front housing portion 10a has a pair of opposite inner wall surfaces in the height direction of the housing 10, and the front ends of two flexible circuit boards 11 are respectively pressed against the pair of inner wall surfaces of the receiving chamber 102 for electrical contact with two rows of terminals 21 on the front and back sides of the tongue portion 20c inserted into the receiving chamber 102.

As shown in FIG. 2, in the illustrated embodiments, an elastic buckle 14 is formed on the top wall of the housing 10, and the elastic buckle 14 has a snap slot 14a suitable for engagement with the protrusion 24a formed on the mating housing 20 of the mating connector 2 to lock connector 1 and mating connector 2 in the mating state.

As shown in FIGS. 1 and 2, in another exemplary embodiment of the present invention, a connector assembly is also disclosed. This connector assembly includes a connector 1 and a mating connector 2. The mating connector 2 is mated with the connector 1.

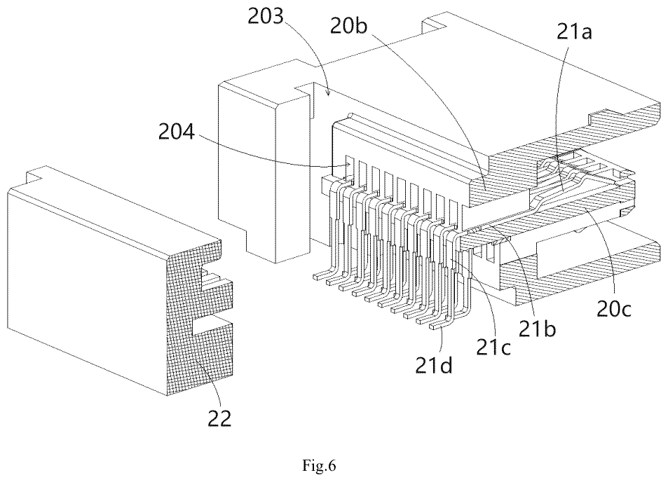

As shown in FIGS. 2 and 3, in the illustrated embodiments, the mating connector 2 includes a mating housing 20, at least one row of terminals 21, and a second sealant 22. The mating housing 20 is formed with at least one row of sockets 204 and a second glue filling cavity 203 communicated with the at least one row of sockets 204, as shown in FIG. 6. At least one row of terminals 21 is inserted into the mating housing 20 through at least one row of sockets 204. The second sealant 22 is formed by the glue filled into the second glue filling cavity 203 and the sockets 204. The glue is filled into the second glue filling cavity 203 and flows into the sockets 204. The second sealant 22 is bonded to the terminals 21 and the mating housing 20 to achieve sealing between the terminals 21 and the mating housing 20. In this way, it can prevent water vapor from entering the mating housing 20 through the gap between the terminals 21 and the mating housing 20.

As shown in FIG. 4, in the illustrated embodiments, the mating housing 20 includes an outer peripheral wall 20a surrounding an inner cavity 201. The front housing portion 10a of connector 1 is inserted into the inner cavity 201 of the mating housing 20, and the seal ring 13 of the connector 1 is radially compressed between the outer peripheral surface of the front housing portion 10a and the inner peripheral surface of the mating housing 20, as shown in FIG. 3.

As shown in FIGS. 4 and 6, in the illustrated embodiments, the mating housing 20 further comprises an end wall 20b connected to the front end of the outer wall 20a, the second glue filling cavity 203 and the socket 204 are formed in the end wall 20b of the mating housing 20 and communicated with the inner cavity 201.

As shown in FIGS. 4 and 6, in the illustrated embodiments, the mating housing 20 further includes a tongue portion 20c, which is located in the inner cavity 201 and connected to the end wall 20b. The terminal 21 includes an elastic arm 21a which is positioned in the positioning groove 202 formed on the tongue portion 20c. The tongue part 20c is inserted into the receiving chamber 102 of the front housing portion 10a, and the elastic arm 21a of the terminal 21 is in electrical contact with the flexible circuit board 11.

As shown in FIG. 6, in the illustrated embodiments, the terminal 21 includes a first fixing part 21b, a second fixing part 21c, and a soldering leg 21d. The first fixing part 21b is fixed in the end wall 20b of the mating housing 20. The second fixing part 21c is fixed in the second sealant 22. The soldering leg 21d is exposed from the bottom of the second sealant 22 and is used for soldering to a circuit board. The first fixing part 21b extends along the longitudinal direction of the mating housing 20, the second fixing part 21c extends along the height direction of the mating housing 20, the first fixing part 21b is connected between the elastic arm 21a and the second fixing part 21c, and the second fixing part 21c is connected between the first fixing part 21b and the soldering leg 21d.

As shown in FIGS. 4 and 6, in the illustrated embodiments, the mating connector 2 comprises an upper row of terminals 21 and a lower row of terminals 21 adjacent to the upper row of terminals 21. A row of positioning slots 202 is formed on the front and back sides of the tongue portion 20c, respectively. The elastic arms 21a of the upper row of terminals 21 are positioned in the row of positioning slots 202 on the front side of the tongue portion 20c, and the elastic arms 21a of the lower row of terminals 21 are positioned in the row of positioning slots 202 on the back side of the tongue portion 20c.

As shown in FIG. 2, in the illustrated embodiments, a protrusion 24a is formed on the top surface of the mating housing 20, which engages with the snap slot 14a of the elastic buckle 14 on the top wall of the housing 10 to lock the connector 1 and the mating connector 2 in the mating state.

In the aforementioned exemplary embodiments of the present invention, the sealant formed by the glue filled into the housing can achieve sealing between the flexible circuit board and the housing, resulting in a higher waterproof level of the connector, such as achieving the waterproof requirements of IP67 or IP68.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing having a slot and a first glue filling cavity communicated with the slot;
a flexible circuit board inserted into the housing through the slot; and
a first sealant formed by a glue filled into the first glue filling cavity and the slot, the first sealant is bonded with the flexible circuit board and the housing to seal between the flexible circuit board and the housing.

2. The connector according to claim 1, further comprising a sealing ring fitted on the housing and compressed between an outer peripheral surface of the housing and an inner peripheral surface of a mating housing of a mating connector, the sealing ring sealing between the housing and the mating housing.

3. The connector according to claim 2, wherein the flexible circuit board is one of a pair of flexible circuit boards spaced apart in a height direction of the housing and overlapping with each other, the slot is one of a pair of slots in the housing, each of the flexible circuit boards is inserted into one of the slots.

4. The connector according to claim 3, wherein the housing has a front housing portion and a rear housing portion opposite to each other in an axial direction, a receiving chamber is formed in the front housing portion that receives a tongue portion of the mating housing.

5. The connector according to claim 4, wherein the slots are formed in the rear housing portion and communicate with the receiving chamber to allow the flexible circuit boards to be inserted into the receiving chamber through the slots.

6. The connector according to claim 4, wherein a sealing ring installation groove is formed on the outer peripheral surface of the front housing portion, the sealing ring is installed in the sealing ring installation groove.

7. The connector according to claim 4, wherein the receiving chamber of the front housing portion has a pair of inner wall surfaces opposite to each other in the height direction of the housing, a pair of front ends of the flexible circuit boards are respectively pressed against the inner wall surfaces of the receiving chamber for electrical contact with a pair of rows of terminals on the tongue portion inserted into the receiving chamber.

8. The connector according to claim 1, wherein an elastic buckle is formed on a top wall of the housing, the elastic buckle has a snap slot suitable for engagement with a protrusion on a mating housing of a mating connector to lock the connector and the mating connector in a mating state.

9. A connector assembly, comprising:
a connector including:
a housing having a slot and a first glue filling cavity communicated with the slot;
a flexible circuit board inserted into the housing through the slot; and
a first sealant formed by a glue filled into the first glue filling cavity and the slot, the first sealant is bonded with the flexible circuit board and the housing to seal between the flexible circuit board and the housing; and
a mating connector mated with the connector.

10. The connector assembly according to claim 9, wherein the mating connector includes a mating housing having a row of sockets and a second glue filling cavity communicated with the row of sockets, a row of terminals is inserted into the mating housing through the row of sockets.

11. The connector assembly according to claim 10, wherein the mating connector includes a second sealant formed by another glue filled into the second glue filling cavity and the sockets, the second sealant is bonded to the terminals and the mating housing to achieve sealing between the terminals and the mating housing.

12. The connector assembly according to claim 11, wherein the mating housing has an outer peripheral wall enclosing an inner cavity, a front housing portion of the connector is inserted into the inner cavity of the mating housing, a sealing ring of the connector is radially compressed between an outer peripheral surface of the front housing portion and an inner peripheral surface of the mating housing.

13. The connector assembly according to claim 12, wherein the mating housing has an end wall connected to a front end of the outer peripheral wall, the second glue filling cavity and the sockets are formed in the end wall of the mating housing and communicate with the inner cavity.

14. The connector assembly according to claim 13, wherein the mating housing includes a tongue portion located in the inner cavity and connected to the end wall, each of the terminals has an elastic arm positioned in a positioning groove formed on the tongue portion, the tongue portion is inserted into a receiving chamber of the front housing portion, the elastic arm of each of the terminals is in electrical contact with the flexible circuit board.

15. The connector assembly according to claim 14, wherein the terminal includes:
a first fixing part, an end of the first fixing part is connected to the elastic arm and fixed in the end wall of the mating housing; and
a second fixing part, an end of the second fixing part is connected to another end of the first fixing part and fixed in the second sealant.

16. The connector assembly according to claim 15, wherein the terminal includes a soldering leg, an end of the soldering leg is connected to another end of the second fixing part and exposed from a bottom of the second sealant for soldering to a circuit board.

17. The connector assembly according to claim 16, wherein the first fixing part extends along a longitudinal direction of the mating housing, the second fixing part extends along a height direction of the mating housing.

18. The connector assembly according to claim 14, wherein the mating connector has an upper row of terminals and a lower row of terminals adjacent to the upper row of terminals, a row of positioning slots is formed on each of a front side and a back side of the tongue portion.

19. The connector assembly according to claim 18, wherein a plurality of elastic arms of the upper row of terminals are positioned in the row of positioning slots on the front side of the tongue portion, and a plurality of elastic arms of the lower row of terminals are positioned in the row of positioning slots on the back side of the tongue portion.

20. The connector assembly according to claim 10, wherein a protrusion is formed on a top surface of the mating housing, the protrusion is engaged with a snap slot of an elastic buckle on a top wall of the housing to lock the connector and the mating connector in a mating state.
